(19) United States
(12) Patent Application Publication
(10) Pub. No.: US 2009/0044023 A1
(43) Pub. Date: Feb. 12, 2009

(54) CONTROL DEVICE WITH AN INTEGRATED USER INTERFACE

(76) Inventors: Alex Crumlin, San Jose, CA (US); Jason Chen, Santa Clara, CA (US); Aaron Leiba, San Francisco, CA (US)

Correspondence Address: IPSG, P.C., P.O. BOX 700640, SAN JOSE, CA, 95170-0640, US

(21) Appl. No.: 11/835,162

(22) Filed: Aug. 7, 2007

(51) Int. Cl. H04L 9/32

(52) U.S. Cl. 713/186

(57) ABSTRACT

A control device for controlling operation of a controlled apparatus is disclosed. The control device may include a sensor configured to acquire a first biometric signal, a second biometric signal, and a third biometric signal. A difference between the first biometric signal and the second biometric signal may be utilized to determine movement of a controlled object. The controlled object may pertain to the operation of the controlled apparatus. At least one of the first biometric signal, the second biometric signal, and the third biometric signal may be utilized to initiate performance of a first function of the controlled apparatus. Further, one or more of the first biometric signal, the second biometric signal, and the third biometric signal may be utilized to determine an identification of a user.

### BACKGROUND OF THE INVENTION

A control device, such as a remote control device, and/or a control module, such as a control panel, may be utilized in controlling the operation of an electronic or electro-mechanical device. For example, the electronic device may be an audio and/or video entertainment device, such as a television set. As another example, the electromechanical device may be a manufacturing apparatus, such as a machine tool. The control device or module may include various user interfaces for navigating one or more menus, adjusting settings, activating functions, entering commands, etc.

FIG. 1A illustrates a schematic representation of an example prior art control device 100 for use in controlling operation of an electronic device. Control device 100 may include a biometric sensor 102, a navigation unit 106, and keys 104 implemented as separate user interfaces and disposed on an exterior surface of an enclosure 108 of electronic device 100.

Biometric sensor 102 may be configured to receive biometric signals. The biometric signals may be processed for identification and/or security purposes.

Navigation unit 106 may be configured for navigating one or more menus shown on a display of the electronic device. Navigation unit 106 may also be configured for adjusting one or more settings of the electronic device, such as a volume setting.

Keys 104 are associated with various functions of the electronic device. For example, the functions may include “playback”, “pause”, “fast forward”, etc. Alternatively or additionally, keys 104 may be associated with different alphabets, numbers, or symbols for user input. Combinations of the alphabets and/or numbers may be utilized for entering usernames and passwords for user identification purposes.

Navigation unit 106 and keys 104 may include mechanical/moving parts configured to generate signals through positional changes, shape changes, contacts, and/or decoupling. After a substantial amount of usage or given inappropriate handling, the mechanical/moving parts may be prone to mechanical failure. The mechanical failure may render navigation unit 106 and one or more of keys 104 useless. Further, the key names imprinted on keys 104 may be rubbed off after a substantial amount of use. As a result, a user might not be able to readily recognize the functions, alphabets, numbers, or symbols associated with the keys.

To enable physical space for the mechanical/moving parts to function, on enclosure 108 gaps may be placed around navigation unit 106 and each of keys 104. Contaminants (such as dust or liquid) may enter control device 100 through the gaps and may cause device 100 to malfunction.

For usability and/or ergonomic considerations, navigation unit 106, keys 104, and biometric sensor 102 may need to have sufficiently large sizes and separations. As a result, miniaturization of device 100 may be obstructed by the sizes and separations of navigation unit 106, keys 104, and biometric sensor 102. As a result, control device 100 may be bulky and may not be aesthetically appealing to users.

FIG. 1B illustrates a block diagram of an example prior art control system 101, including navigation unit 106, keys 104, and biometric sensor 102 of control device 100 discussed with reference to the example of FIG. 1A. In control system 101, a processing unit 118 may process a biometric signal, such as a fingerprint or retina pattern, received from biometric sensor 102 and may communicate with an identification/authentication database 112 to determine identification, authentication, authorization, and/or accounting arrangements associated with the biometric signal. Accordingly, processing unit 108 may provide a command to functional units 121 to execute the arrangements. For example, processing unit 108 may send a command to allow or disallow a user's access to a user account. Output device 120 may provide a message associated with the arrangements.

Processing unit 118 may also receive input from keys 104. The input from keys 104 may include signals associated with commands, alphabets, numbers, symbols, combinations of the above, etc. for a function/action. With the input from keys 104, processing unit 118 may communicate with a key-function mapping table 114 to determine the requested function/action. Accordingly, processing unit 118 may send a command to functional units 121 to perform the requested function/action. In turn, output device 120 may provide images and/or sounds associated with the requested function/action.

Processing unit 118 may also receive input from navigation device 106. With the input from navigation device 106, processing unit 118 may communicate with a navigation algorithm module 116 to determine the requested navigation, such as movement of a pointer, highlight of a menu item, or selection of the menu item. Processing unit 118 may then provide a command associated with the navigation request to functional units 121. In turn, output device 120 may provide images and/or sounds associated with the navigation request, such as displaying the movement of the pointer.

FIG. 1C illustrates a schematic representation of a prior art key-function mapping arrangement; for example, the key-function mapping between keys in 104 and functions provided by functional units 121 illustrated in the example of FIG. 1B. The mapping arrangement may associate each key with a function. For example, each of keys 132-138 may be individually associated with each of functions 142-148, respectively. For a large number of functions, a large quantity of keys may be required. As previously discussed, the physical sizes and separations of the keys may obstruct miniaturization of the control device. The implementation and layout of the keys may complicate the manufacture of the control devices.

### SUMMARY OF INVENTION

An embodiment of the present invention relates to a control device for controlling operation of a controlled apparatus. The control device may include a sensor configured to acquire a first biometric signal, a second biometric signal, and a third biometric signal. A difference between the first biometric signal and the second biometric signal may be utilized to determine movement of a controlled object. The controlled object may pertain to the operation of the controlled apparatus. At least one of the first biometric signal, the second biometric signal, and the third biometric signal may be utilized to initiate performance of a first function of the controlled apparatus. Further, one or more of the first biometric signal, the second biometric signal, and the third biometric signal may be utilized to determine an identification of a user.

The above summary relates to only one of the many embodiments of the invention disclosed herein and is not intended to limit the scope of the invention, which is set forth is the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates a schematic representation of an example prior art control device for use in controlling operation of an electronic device.

FIG. 1B illustrates a block diagram of an example prior art control system.

FIG. 1C illustrates a schematic representation of a prior art key-function mapping arrangement.

FIG. 2A illustrates a schematic representation of a control device in accordance with one or more embodiments of the present invention.

FIG. 2B illustrates a block diagram of a control system in accordance with one or more embodiments of the present invention.

FIG. 2C illustrates a schematic representation of an arrangement of association/mapping between sensed human-body features and identifications, functions, and navigation actions.

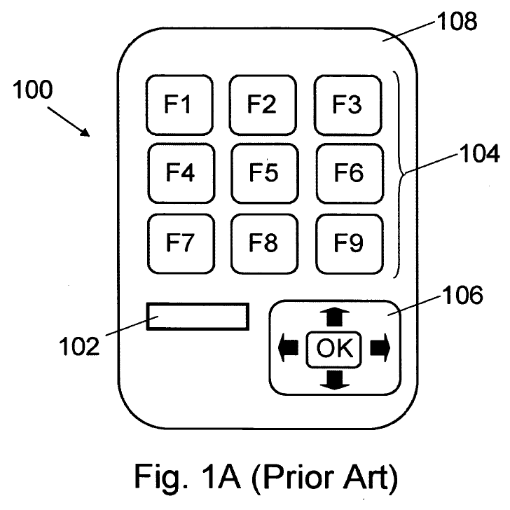

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

One or more embodiments of the invention relate to a control device for controlling operation of a controlled device, such as an electronic or electromechanical device. For example, the electronic device may be one or more of a computing device (e.g., a computer), a communications device (e.g., a cellular phone), and an entertainment device (e.g., a television, audio/video player, or game console). For example, the electromechanical device may include one or more of a manufacturing apparatus (e.g., a machine tool), a robot, and a vehicle.

The control device may include a sensor configured to acquire a first biometric signal, a second biometric signal, and a third biometric signal. The sensor may include one or more of a thermal sensor, a capacitive sensor, an image sensor, a voice sensor, a conductivity sensor, a weight sensor, a retina sensor, and a light sensor.

A difference between the first biometric signal and the second biometric signal may be utilized in determining movement of a controlled object. The controlled object may pertain to the operation of the controlled apparatus. For example, the controlled object may be at least one of a pointer and a highlighted portion on a display of the controlled apparatus.

At least one of the first biometric signal, the second biometric signal, and the third biometric signal may be utilized in initiating performance of a first function of the controlled apparatus. Further, one or more of the first biometric signal, the second biometric signal, and the third biometric signal may be utilized in determining an identification of a first user.

The first biometric signal and the second biometric signal may be associated with at least a first human-body feature of the first user. For example, the first biometric signal and the second biometric signal may be associated with at least one of a fingerprint, a palm print, a toe print, a retina pattern, a facial feature, and a voice of the first user. The third biometric signal may be associated with at least a second human-body feature of the first user.

The control device may include a plurality of sensors configured to acquire biometric signals associated with a plurality of human-body features of the first user, wherein the sensor may be one of the sensors. The plurality of sensors may be arranged according to relative positions of the plurality of human-body features of at least the first user.

One or more embodiments of the invention may relate to a control system. The control system may include the control device as discussed above. The control system may also include a processor configured to determine the movement of the controlled object based on the difference between the first biometric signal and the second biometric signal. The processor may be also configured to initiate the performance of the first function of the controlled apparatus based on the at least one of the first biometric signal, the second biometric signal, and the third biometric signal. The processor may be further configured to determine the identification of the first user based on the one or more of the first biometric signal, the second biometric signal, and the third biometric signal.

The control system may further include different mapping arrangements (or mapping tables) for different users. For example, the control system may include first logic (or mapping arrangement/table) configured to associate various human-body features of the first user with various functions of the controlled apparatus, various configurations of the controlled apparatus, various configurations of a service provide through the controlled apparatus, and/or various services provided through the controlled apparatus. The control system may further include second logic (or mapping arrangement/table) configured to associate various human-body features of a second user with various functions of the controlled apparatus, various configurations of the controlled apparatus, various configurations of a service provided through the controlled apparatus, and various services provided through the controlled apparatus. The various human-body features may include one or more of fingerprints, palm prints, toe prints, retina patterns, voices, and tunes.

The control system may also include logic (or mapping arrangement/table) configured to associate at least one of various fingerprints, various fingerprint combinations, various fingerprint sequences, and various fingerprint motions (for example, including directions, velocities, and displacements) of the first user with various service accounts, various security levels of an account, and/or various service lists of the account. The service accounts, security levels, and service lists may pertain to services provided through the controlled apparatus.

The control system may further include a learning module configured to gather/produce user-specific information associated with the first user based on data pertaining to one more or more of first biometric signal, the second biometric signal, the third biometric signal, and the difference between the first biometric signal and the second biometric signal. For example, the user-specific information may include one or more of user preference information, user behavior information, use history information, and information for resumption of a task performed by the controlled apparatus.

The features and advantages of the present invention may be better understood with reference to the figures and discussions that follow.

FIG. 2A illustrates a schematic representation of a control device 200 in accordance with one or more embodiments of the present invention. Control device 200 may include a sensor 202 that is seamlessly integrated with the industrial design of control device 200.

Sensor 202 may include one or more of a capacitive sensor, a retinal sensor, an image sensor, a weight sensor, a pressure sensor, a thermal sensor, a light sensor, etc. configured to receive one or more biometric signals pertaining to one or more human-body features. For example, the one or more human-body features may include one or more of fingerprints, palm prints, toe prints, retina patterns, voices, tunes, weight, height, impedance, energy distribution, etc. Sensor 202 may also be configured to serve as a touchpad (or track pad) of control device 200. Accordingly, sensor 202 may be utilized for multiple control purposes, such as identification, authentication, authorization, navigation, and entry of commands and alphanumerical signals.

Advantageously, there may be zero or a minimum number of mechanical moving parts in control device 200, and control device may be more reliable and durable than prior art control devices with comparable functionality. Further, control device 200 may have a substantially smaller form factor than form factors of prior art control devices with comparable functionality.

FIG. 2B illustrates a block diagram of a control system 201 in accordance with one or more embodiments of the present invention. Control system 201 may include a processing unit 208 configured to receive various biometric signals from sensor 202. The biometric signals may include one or more human-body features (e.g., ridges of fingerprints) and/or associated changes/movement (e.g., a difference between a first thermal image and a second thermal image of fingerprint ridges). Processing unit 208 and associated logic/modules may be implemented in control device 200 (illustrated in the example of FIG. 2A), in a controlled apparatus that is controlled by control device 201, or a host apparatus in communication with the controlled apparatus. Alternatively or additionally, processing unit 208 and the associated logic/modules may be distributed in multiple devices.

With the biometric signals received from sensor 202, processing unit 208 may communicate with various modules, such as an identification/authentication database 212, feature-function mapping logic 214, and/or a navigation algorithm module 216 for determining associated requested actions/functions. Processing unit 208 may also process the biometric signals and provide relevant data to a learning module 222.

Learning module 222 may analyze the data from processing unit 208 to accumulate biometric signal data and to establish patterns of user behaviors and preferences. For example, at different uses, a user might input incomplete fingerprint images through sensor 202. Accumulating the incomplete fingerprint images, learning module 222 may be able to establish a complete image of the user's fingerprint. Advantageously, subsequent user input may be recognized and processed in a faster and more reliable fashion. Learning module 222 may also analyze user behavior for configuring the controlled apparatus according to user preferences.

Control system 201 may also include a user database 224 for storing the results of analysis performed by learning module 222.

After determining the requested actions/functions based on communication with identification/authentication database 212, feature-function mapping logic 214, and/or navigation algorithm module 216, and receiving relevant information from user database 224, processing unit 208 may send one or more commands to functional units 221 of the controlled apparatus to perform the requested actions/functions. Accordingly, output device 220 may provide/perform images, sounds, and/or actions associated with the requested actions/functions.

In one or more embodiments, one or more of sensor 202 and navigation algorithm module 216 may be conventionally available from one or more vendors, such as AuthenTec, Inc. (www.authentec.com), Atmel Corporation (www.atmel.com), and Validity Sensors, Inc. (www.validityinc.com).

FIG. 2C illustrates a schematic representation of an arrangement of association/mapping between sensed human-body features and identifications, functions, and navigation actions performed by one or more of processor 208, identification/authentication database 212, feature-function mapping logic 214, and navigation algorithm module 216 (illustrated in the example of FIG. 2B) in accordance with one or more embodiments of the present invention.

Object features (or human-body features) and combinations, sequences, and/or movement thereof may be associated with user IDs, user accounts, and one or more of privilege, service, and security levels. For example, for a first user, a fingerprint 232 may be associated with a user ID 268 for a user account 295. The user may be able to access user account 295 by applying a finger (e.g., the right thumb) to sensor 202 to provide fingerprint 232, without typing a username and a password.

The user may be able to access a different user account 297 by applying a different finger (e.g., the left index finger) to sensor 202 to provide a fingerprint 234. Finger 234 may be associated with user ID 270 for user account 297. User ID 270 may be associated with a set of privileges, preferences, and configurations for user account 297. Multiple fingerprints, such as fingerprint 234 and 236, may be associated with one user ID, such as user ID 270. Different fingerprints may also be associated with different privileges, service, and/or security levels of the same user account. For example, fingerprint 234 may be associated with a higher security level than fingerprint 236 when user account 297 is utilized.

The histories of access to and use of various accounts may be stored in a user behavior/history database 299 in user database 224.

Human-body features and combinations, sequences, and/or movement thereof may also be associated with functions/actions and alphanumerical signals. For example, different fingerprints, such as fingerprints 232-236, may also be associated with the same or different functions, such as functions 272-276 of functional units 221 (illustrated in the example of FIG. 2B) the controlled apparatus. Fingerprint combinations, such as fingerprint combinations 242-246 (e.g., left thumb plus right ring fingerprints), may also be associated with the same or different user IDs and/or the same or different functions, such as functions 282-286. Fingerprint sequences, such as fingerprint sequence 252-256 (e.g., left index finger print then right thumb print), may also be associated with the same or different user IDs and/or the same or different functions, such as functions 292-296.

Human-body feature movement and changes may be associated with navigation actions or movement of a controlled object. For example, fingerprint movement 262 may be associated with navigation actions, or controlled object movement 298. For example, controlled object movement 298 may represent movement of a pointer, highlight or selection of a menu item, or movement of a robot arm.

Fingerprints, fingerprint combinations, and/or fingerprint sequences may also be associated with controlled object movement 298. For example, fingerprint 232, fingerprint 234, fingerprint combination 244, and fingerprint combination 246 may represent “up,” “down,” “left,” and “right,” respectively, of controlled object movement 298.

The use and/or performance of the user IDs, functions, and navigation actions (or controlled object movement) may be analyzed by learning module 222 with results stored in user database 224. User database 224 may store data (such as mapping arrangements) pertaining to various users.

The input of all the fingerprints, fingerprint combinations, fingerprint sequences, and fingerprint movement may all be received through sensor 202, without being received by separate user interface parts.

Examples of alternative or additional embodiments of the present invention are further discussed below. The alternative or additional embodiments may be categorized into four example areas: (1) security, (2) applications, (3) remote control, and (4) digital right management (DRM).

(1) Security

(1.1) Logging into a user account—An operating system, such as Mac OS X, may be designed for multiple users. Each of the users may have one or more accounts. The conventional method or system for accessing an account may include typing in a username and a password.

In one or more embodiments of the invention, alternative to or in addition to password entry, with the use of fingerprint sensors, account access may be granted with the use of a user's fingerprint. For example, when the option to enter the various accounts appears on the screen, the user may simply apply a finger to a fingerprint sensor, and the system will automatically open to that user's account. Potential embodiments may be utilized in multiple accounts (e.g., home/work accounts) and shared computers.

(1.2) Opening the computer—Upon a touch by a user, a laptop computer may automatically open and access the correct user account as determined by the finger of the user used. In one or more embodiments, a fingerprint sensor would be place where the lid latch/button of the laptop computer resides. Instead of pressing the latch/button, the user may place/swipe a finger to trigger the laptop computer to open. Subsequently, the operating system (OS) of the laptop computer may begin in the user account associated with the finger. If a non-valid finger is used, an LED indication may display, the computer may not open, and the OS may not start.

(1.3) Passwords and Credit card numbers—Conventionally, a user may have different usernames, different account numbers, and (different) passwords for various service accounts, such as email accounts, bank accounts, credit card accounts, etc. Remembering all account information may be burdensome.

In one or more embodiments, a fingerprint sensor may allow a user to enter the correct username and password for an account based upon the fingerprint swiped in. The user may not need to type the username and the password. Individual fingers may be assigned to user accounts, websites, and applications. Alternatively or additionally, a user may have one finger assigned for authentication for all user accounts, websites, and/or applications, and the correct username and password may be automatically provided by the instant user account, website, and/or application.

(1.4) Different sensors/directions for different applications—In one or more embodiments, a swipe sensor may be used. Swiping a finger in a first direction (e.g., “down”) may result in a predefined OS or application hotkey functionality. Swiping the finger in a second direction (e.g., “up”) may result in a username/password/credit card input.

Alternatively or additionally, two sensors or more sensors may be employed. The user may associate functions/accounts with sensors and fingers. For example, on the left-side sensor, the hot keys may be fingers from the left hand, and the passwords may be fingers from the right hand.

(2) Applications

(2.1) Replacing function keys—In one or more embodiments, instead of pressing different function keys, a user may apply different fingers to a single fingerprint sensor for launching and operating different applications and/or tasks.

(2.2) Using a fingerprint sensor as a specialized function key on a keyboard—In one or more embodiments, one of the function keys (like F1 or F6) may be replaced with a fingerprint sensor. Alternatively or additionally, a fingerprint sensor may be added as a new function key. The fingerprint sensor may be disposed near the arrow keys (there may be unused spaces above the left and right arrow keys), on the palm area, near the touchpad, or somewhere in the middle of the keyboard at a different location. A fingerprint sensor may be centrally located (easy access for fingers on both hands). Alternatively or additionally, one sensor may be disposed on each side of a keyboard so that each hand may have easy access to a sensor.

(2.3) Different actions for different applications—In one or more embodiments, different fingers, different finger movement directions, and different sensors may be utilized for launching/performing different tasks within different applications. For example, a finger may be associated with a certain play list within a media player account or a media player. For example a user may enter 10 possible play list selections utilizing 10 different fingers.

(3) Remote Control

(3.1) Replacing the remote control that comes with an electronic device (e.g., a computer, television, or a media player)—In one or more embodiment, a conventional remote control unit may be replaced with a control device with a fingerprint sensor. The control device with a fingerprint sensor may have a substantially smaller form factor. The fingerprint sensor may be used to perform various control functions, such as adjusting volume, playing back, selecting channels, etc.

(3.2) Different finger/user associated with different service list (e.g. play list)—In one or more embodiments, the swiping of different fingers of different users may result in different play lists being selected. In one or more embodiments, the thumbs are not registered (so as to not affect the scrolling/volume). Other fingers may bring up different playlists, services, or content.

(3.3) ExpressCard remote control device with a fingerprint sensor—One or more embodiments of the invention may be an ExpressCard peripheral that may be charged and stored in an ExpressCard slot. The sensor part may be exposed to receive user input, and the remote control device may communicate with a computer through the ExpressCard slot. In one or more embodiments, the sensor part may be concealed and may be exposed when user input is needed.

(3.4) Authorizing sharing of a service/content on a different apparatus—In one or more embodiments, a user may activate a service (e.g., streaming of video content) on multiple controlled apparatuses (e.g., media players) by applying a finger associated with a certain user account and the service to a fingerprint sensor on a remote control device, and launching the service on each of the controlled apparatuses with the remote control device.

(4) Digital Rights Management (DRM)

(4.1) Using fingerprints to authorize (temporary) use of services—In one or more embodiments, a template of fingerprints may be stored on a media server. A user may swipe a finger on a Fingerprint sensor of any media player or computer to have access to content that has restricted access due to DRM.

(4.2) Implementing fingerprint sensors on media players or hosts of the media players to authorize sharing—In one or more embodiments, a fingerprint may be associated with a digital rights certificate that may be set to expire after a predefined period if the service/content associated with the certificate is not purchased.

As can be appreciated from the foregoing, embodiments of the invention provide one single user interface for input of identification information, function requests, and navigation commands. Advantageously, embodiments of the invention may substantially reduce form factors of control devices.

Embodiments of the invention may also eliminate mechanical parts that are required in conventional control devices. Advantageously, reliability and durability of control devices may be improved.

Embodiments of the invention may also enable seamless integration of user interfaces within controlled devices. Advantageously, aesthetics of the control devices may be improved, and maintenance of the control devices may be simplified.

Embodiments of the invention may also enable controlled apparatuses (e.g., electronic or electromechanical devices) to perform functions and provide services in a personalized fashion, without substantial training or configuration on the controlled apparatuses being required. Advantageously, user experience may be improved.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A control device for controlling operation of a controlled apparatus, the control device comprising:
a sensor configured to acquire a first biometric signal, a second biometric signal, and a third biometric signal,
wherein a difference between the first biometric signal and the second biometric signal is used to determine movement of a controlled object, the controlled object pertaining to the operation of the controlled apparatus,
at least one of the first biometric signal, the second biometric signal, and the third biometric signal is used to initiate performance of a first function of the controlled apparatus, and
one or more of the first biometric signal, the second biometric signal, and the third biometric signal is used to determine an identification of a user.

2. The control device of claim 1 wherein the sensor includes one or more of a thermal sensor, a capacitive sensor, an image sensor, a voice sensor, a conductivity sensor, a retina sensor, a light sensor, and a weight sensor.

3. The control device of claim 1 wherein the first biometric signal and the second biometric signal are associated with at least a first human-body feature of the user.

4. The control device of claim 3 wherein the third biometric signal is associated with at least a second human-body feature of the user.

5. The control device of claim 1 wherein the first biometric signal and the second biometric signal are associated with at least one of a fingerprint, a palm print, a toe print, a facial feature, an energy distribution, an impedance, and a voice of the user.

6. The control device of claim 1 comprising a plurality of sensors configured to acquire biometric signals associated with a plurality of human-body features of the user, the sensor being one of the plurality of sensors.

7. The control device of claim 6 wherein the plurality of sensors is arranged according to relative positions of the plurality of human-body features of at least the user.

8. The control device of claim 1 wherein the controlled object is at least one of a pointer and a highlighted portion on a display of the controlled apparatus.

9. A control system for controlling operation of a controlled apparatus, the control system comprising:
a sensor configured to acquire a first biometric signal, a second biometric signal, and a third biometric signal; and
a processor configured to determine movement of a controlled object based on a difference between the first biometric signal and the second biometric signal, the controlled object pertaining to the operation of the controlled apparatus, the processor further configured to initiate performance of a first function of the controlled apparatus based on at least one of the first biometric signal, the second biometric signal, and the third biometric signal, the processor further configured to determine an identification of a first user based on one or more of the first biometric signal, the second biometric signal, and the third biometric signal.

10. The control system of claim 9 further comprising logic configured to associate various human-body features of the first user with various functions of the controlled apparatus, the logic further configured to associate a plurality of human-body features of a second user with a plurality of functions of the controlled apparatus.

11. The control system of claim 9 further comprising logic configured to associate various human fingerprints with various functions of the controlled apparatus.

12. The control system of claim 9 further comprising logic configured to associate various human fingerprint combinations with various functions of the controlled apparatus.

13. The control system of claim 9 further comprising logic configured to associate various human fingerprint sequences with various functions of the controlled apparatus.

14. The control system of claim 9 further comprising logic configured to associate various human fingerprint motions with various functions of the controlled apparatus.

15. The control system of claim 9 further comprising different mapping arrangements for different users, the different mapping arrangements configured to associate at least one of various functions of the controlled apparatus, various configurations of the controlled apparatus, and various services provided through the controlled apparatus with at least one of various human fingerprints, various human fingerprint combinations, various human fingerprint sequences, and various human fingerprint motions.

16. The control system of claim 9 further comprising logic configured to associate various fingerprints of the first user with at least one of various service accounts of the first user, various security levels of an account, and various service lists of the account.

17. The control system of claim 9 further comprising logic configured to associate at least one of various fingerprints, various fingerprint combinations, various fingerprint sequences, and various fingerprint motions of the first user with various service accounts of the first user, the service accounts pertaining to services provided through the controlled apparatus.

18. The control system of claim 9 further comprising logic configured to associate at least one of various fingerprints, various fingerprint combinations, various fingerprint sequences, and various fingerprint motions of the first user with at least one of various configurations of the controlled apparatus, various configurations of a service provided through the controlled apparatus, and various services provided through the controlled apparatus.

19. The control system of claim 9 further comprising a learning module configured to produce user-specific information associated with the first user based on data pertaining to one more or more of first biometric signal, the second biometric signal, the third biometric signal, and the difference between the first biometric signal and the second biometric signal.

20. The control system of claim 19 wherein the user-specific information includes information for resumption of a task performed by the controlled apparatus.
